(19) United States
(12) Patent Application Publication
(10) Pub. No.: US 2011/0291421 A1
(43) Pub. Date: Dec. 1, 2011

(54) Wind-Deflection Omni-Directional Vertical Wind-Driven Device

(76) Inventor: Fang Ming Tsung, Yuli Township (TW)

(21) Appl. No.: 12/791,102

(22) Filed: Jun. 1, 2010

(51) Int. Cl. F03D 3/04; F03D 9/00

(52) U.S. Cl. 290/55

(57) ABSTRACT

The present invention provides a wind-driven rotary device disposed on a wind power generator, and particularly a wind-driven device with vertical vanes that provide effects of wind deflection, omni-direction and wind collection. The wind-driven device is characterized in that: upright columns are disposed above the wind power generator, vertical arc-shaped rotary vanes are disposed at a central position among the upright columns, and each of the upright columns is provided with an arc-shaped wind deflector that is inclined inwards on an inner edge thereof. In implementation of the present invention, a wind collector may be additionally provided on an outer edge of each of the upright columns to increase volume of the wind so that a larger torsional force can be generated by the vanes of the wind-driven rotary device to deliver a better effect of wind power generation.

### BACKGROUND OF THE INVENTION

1. Technical Field

The present invention relates to a wind-driven rotary device for use in a wind power generator. The wind-driven rotary device has a reinforced structure and allows for more efficient conversion of wind energy into mechanical energy of the wind power generator. The wind-driven rotary device is characterized in that: above the wind power generator there are upright columns disposed, arc-shaped vertical rotary vanes are disposed at a central position among the upright columns, and each of the upright columns is provided with an arc-shaped air-deflector that is inclined inwards on an inner edge thereof, wherein, each of the upright columns is additionally provided with an air-collector on an outer edge thereof. The wind-driven device with vertical vanes that provide effects of air deflection, omni-direction and air collection can improve the effect of the wind power generation.

2. Description of Related Art

Due to continuous and heavy destruction of the forests, undue exploitation of energy sources and excessive exhaust of carbon dioxide by the human beings, the earth is now experiencing the ever greatest air quality catastrophe such as the serious greenhouse effect and thawing of ice in the North Pole, and it seems that the situation is continuing to become worse. Therefore, how to protect the earth has become the most urgent problem for green organizations or those who are concerned about the earth's ecosystem all over the world.

As is known, utilizing and converting natural energy sources such as solar energy, wind power, geothermal energy or tidal energy into economical and practical energy sources to replace coals and petrochemical products is the most environment-friendly way of obtaining alternative energy sources. Unfortunately, conversion of solar energy, geothermal energy and tidal energy necessitates using devices and equipment that have high manufacturing costs, complex structures and are difficult to maintain, resulting in poor cost-effectiveness. Consequently, such energy sources have never been widely utilized to date.

On the other hand, conversion of wind power into electric power necessitates using equipment that has a low manufacturing cost, a simple structure and is relatively simple to maintain, so wind power devices have been widely installed and used in countries all over the world. However, the major disadvantage of wind power application is that the wind energy source is relatively instable. For example, conditions of the “wind” on the earth surface or on the sea surface such as continuity, speed, turbulent flows and instantaneous gusts are known as the main factors that dominate the efficacy of wind power generation. Hence, wind at an excessively low speed may fail to drive vanes of the conventional wind power generator. Conversely, wind at an excessively high speed or intensity may bring about a risk of throwing down the towering wind power generation equipment due to the strong wind.

Accordingly, out of safety considerations, the rotary vanes of conventional wind power generators are made to be flat vanes with a very small width. Such narrow vanes fail to collect and convert a large volume of wind into kinetic energy necessary for the generator. Therefore, the wind-driven devices of the conventional wind power generators still have a large room for improvement.

### BRIEF SUMMARY OF THE INVENTION

In order to overcome the problems with the wind-driven devices of the conventional wind power generators, the present inventor has been motivated by an intention of developing a wind power device, and after a long time of research based on years of experience in machinery sectors, finally accomplishes the “air-deflection omni-directional vertical wind-driven device” of the present invention.

The present invention makes substantial alterations to the wind-driven rotary device disposed on the wind power generator. The wind-driven rotary device is provided with upright columns above the wind power generator, and at a central position among the upright columns, vertical arc-shaped rotary vanes are disposed. Each of the upright columns is provided with an arc-shaped air-deflector that is inclined inwards on an inner edge thereof. Thus, a wind-driven device with good performance is obtained.

Furthermore, in an implementation of the present invention, each of the upright columns may be additionally provided with a wind collector on an outer edge thereof to enhance the effects of air deflection, omni-direction and wind collection so that efficacy of vane rotation and wind power generation will be even better.

### BRIEF DESCRIPTION OF THE SEVERAL VIEWS OF THE DRAWINGS

The invention as well as a preferred mode of use and advantages thereof will be best understood by referring to the following detailed description of illustrative embodiments in conjunction with the accompanying drawings, wherein:

FIG. 1 is a perspective view of the present invention;

FIG. 2 is an exploded perspective view of an upper box of the present invention;

FIG. 3 is a top view of the present invention;

FIG. 4 is a perspective view of an embodiment of the present invention in which a wind collector is additionally provided;

FIG. 5 is a perspective view of an embodiment of the present invention in which the upper box is shown in an exploded form and a wind collector is additionally provided; and

FIG. 6 is a top view of an embodiment of the present invention in which a wind collector is additionally provided.

### DETAILED DESCRIPTION OF THE INVENTION

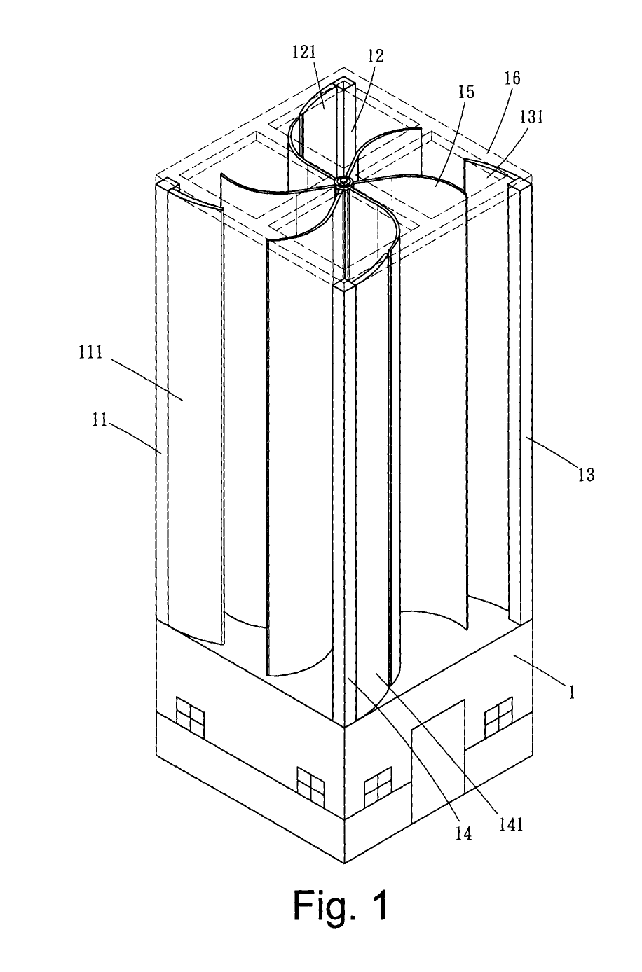

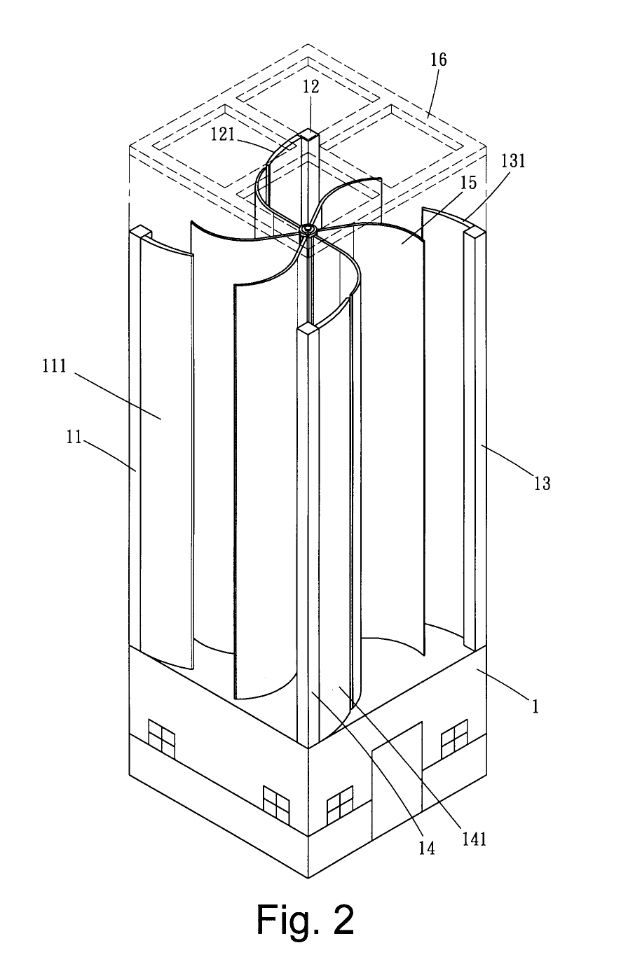

Referring to FIG. 1 and FIG. 2, an air-deflection omni-directional vertical wind-driven device of the present invention primarily comprises a wind-driven device disposed on a wind power generator (1). In the wind-driven device, a plurality of upright columns (11), (12), (13), (14) is disposed above the wind power generator (1), and at a central position among the upright columns (11), (12), (13), (14) that corresponds to a spindle of the wind power generator (1), a vertical arc-shaped rotary vane assembly (15) consisting of a plurality of arc-shaped vanes is disposed. Each of the upright columns (11), (12), (13), (14) is provided with an arc-shaped air deflector (111), (121), (131), (141) that is inclined inwards at an inner edge thereof, and an upper box reinforced structure (16) is fixed above the upright columns (11), (12), (13), (14).

The upper box reinforced structure (16) may be an airtight enclosed box or an open box.

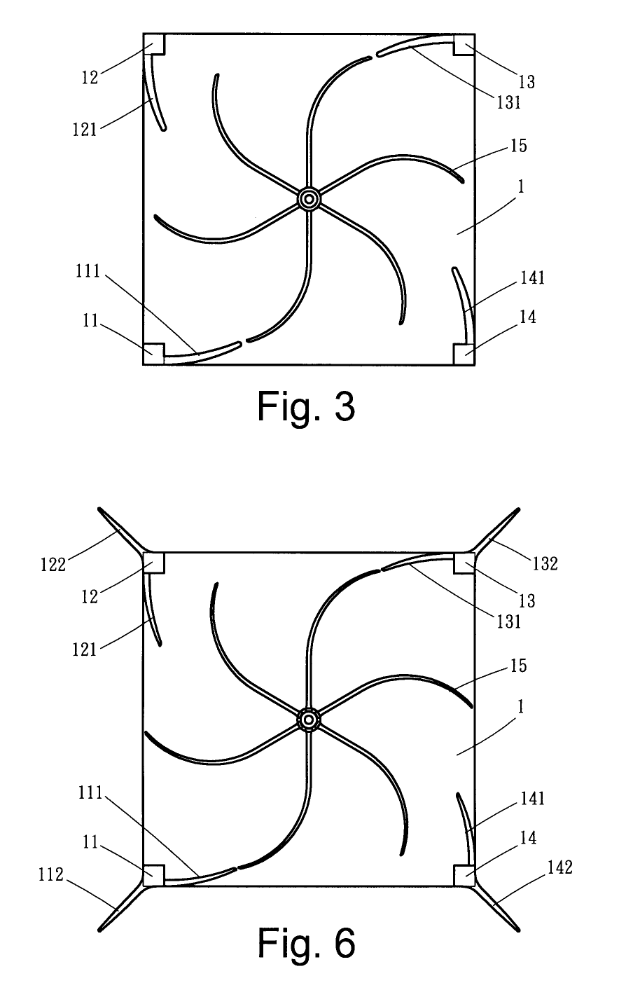

Referring to FIG. 3, for the wind-driven device of the present invention, no matter in which direction the wind is blowing, the arc-shaped air deflectors (111), (121), (131), (141) and the arc-shaped surfaces of the vertical arc-shaped rotary vanes (15) will guide the wind to push the arc-shaped rotary vane assembly (15) to rotate in a same direction, thereby driving the spindle of the wind power generator (1) to rotate. Moreover, the large windward surfaces of the vertical arc-shaped rotary vanes (15) allow for collection and utilization of most of kinetic energy of the wind.

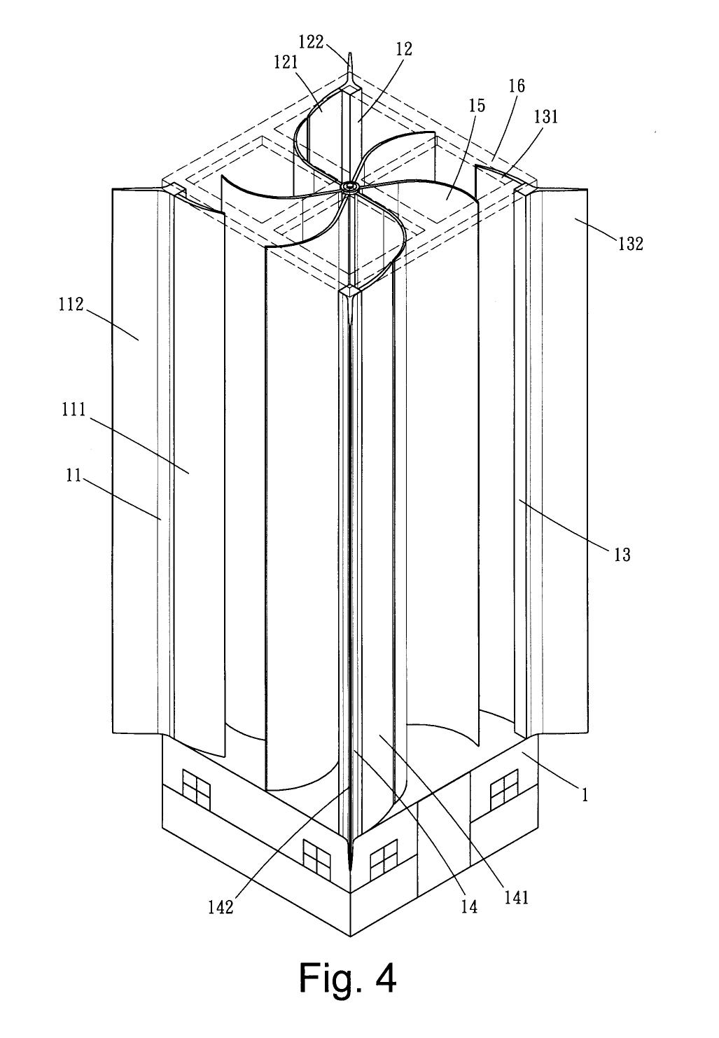

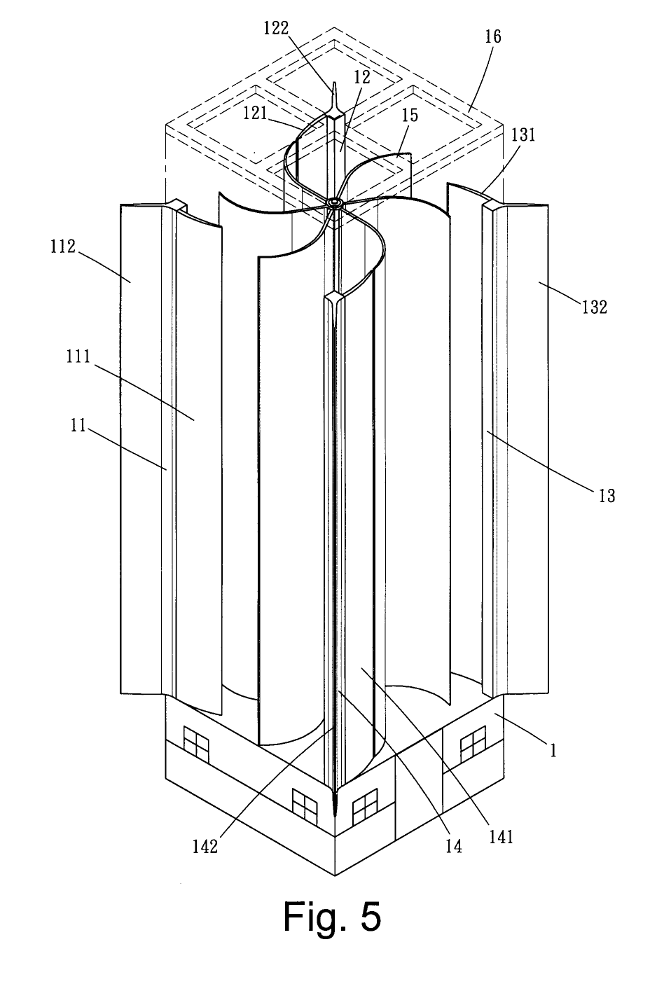

Referring to FIG. 4 to FIG. 6, in implementation of the present invention, an upright wind collector (112), (122), (132) or (142) may be additionally provided on an outer edge of each of the upright columns (11), (12), (13) and (14) to collect and guide the wind passing the air intakes effectively, thereby increasing the pushing force against the vertical arc-shaped rotary vanes (15). Obviously, the wind collecting function can promote rotation of the vertical arc-shaped rotary vanes (15) and improve efficacy of wind power generation.

1. An air-deflection omni-directional vertical wind-driven device, primarily comprising a wind-driven device disposed on a wind power generator (1), in the wind-driven device, a plurality of upright columns (11), (12), (13), (14) being disposed above the wind power generator (1), and at a central position among the upright columns (11), (12), (13), (14) that corresponds to a spindle of the wind power generator (1), a vertical arc-shaped rotary vane assembly (15) comprising a plurality of arc-shaped vanes being disposed, each of the upright columns (11), (12), (13), (14) being provided with an arc-shaped air deflector (111), (121), (131), (141) that is inclined inwards on an inner edge thereof, and an upper box reinforced structure (16) being fixed above the upright columns (11), (12), (13), (14).

2. The air-deflection omni-directional vertical wind-driven device of claim 1, wherein the upper box reinforced structure (16) is an airtight enclosed box or an open box.

3. The air-deflection omni-directional vertical wind-driven device of claim 1, wherein an upright wind collector (112), (122), (132), (142) is additionally provided on an outer edge of each of the upright columns (11), (12), (13), (14) to promote rotation of the vertical arc-shaped rotary vane assembly (15) and improve efficacy of wind power generation.
